(19) United States
(12) Patent Application Publication
(10) Pub. No.: US 2025/0048239 A1
(43) Pub. Date: Feb. 6, 2025

(54) SLICE SUPPORT AVAILABILITY CHECKING METHOD AND USER EQUIPMENT

(71) Applicant: KYOCERA Corporation, Kyoto-shi (JP)

(72) Inventors: Mitsutaka HATA, Yokohama-shi (JP); Masato FUJISHIRO, Yokohama-shi (JP)

(73) Assignee: KYOCERA Corporation, Kyoto-shi (JP)

(21) Appl. No.: 18/920,255

(22) Filed: Oct. 18, 2024

Related U.S. Application Data
(63) Continuation of application No. PCT/JP2023/015300, filed on Apr. 17, 2023.

(30) Foreign Application Priority Data
Apr. 20, 2022 (JP) 2022-069719

(51) Int. Cl. H04W 48/16; H04W 36/08; H04W 48/18

(52) U.S. Cl. CPC H04W 48/16; H04W 36/08; H04W 48/18

(57) ABSTRACT

A slice support checking method according to an aspect is a slice support availability checking method in a mobile communication system. The slice support checking method includes a step of transmitting, at a base station, a message including a first list and/or a second list. Furthermore, the slice support checking method includes a step of determining, at a user equipment, whether a cell supports a network slice in an application area based on the presence or absence of the first list and the second list. Here, the first list represents first network slices that a cell supports, and the second list represents second network slices that the cell does not support.

### RELATED APPLICATIONS

The present application is a continuation based on PCT Application No. PCT/JP2023/015300, filed on Apr. 17, 2023, which claims the benefit of Japanese Patent Application No. 2022-069719 filed on Apr. 20, 2022. The content of which is incorporated by reference herein in their entirety.

### TECHNICAL FIELD

The present disclosure relates to a slice support availability checking method and a user equipment in a mobile communication system.

### BACKGROUND

In the specifications of The Third Generation Partnership Project (3GPP) (registered trademark; the same applies hereinbelow), which is a standardization project for mobile communication systems, network slicing is defined (for example, see Non-Patent Document 1). Network slicing is a technique of logically dividing a physical network constructed by a telecommunications carrier to configure network slices that are virtual networks.

### CITATION LIST

### Non-Patent Literature

Non-Patent Document 1: 3GPP TS 38.300 V16.8.0 (2021-12)

### SUMMARY

A slice support checking method according to an aspect is a slice support availability checking method in a mobile communication system. The slice support checking method includes a step of transmitting, at a base station, a message including a first list and/or a second list. Furthermore, the slice support checking method includes a step of determining, at a user equipment, whether a cell supports a network slice in an application area based on the presence or absence of the first list and the second list. Here, the first list represents first network slices that a cell supports, and the second list represents second network slices that the cell does not support.

A user equipment according to an aspect is a user equipment in a mobile communication system. The user equipment includes a receiver configured to receive a message including the first list and/or the second list from a base station. Furthermore, the user equipment includes a controller configured to determine whether a cell supports a network slice in an application area based on the presence or absence of the first list and the second list. Here, the first list represents first network slices that the cell supports, and the second list represents second network slices that the cell does not support.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram for illustrating an overview of a cell reselection procedure.

FIG. 7 is a flowchart indicating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a diagram illustrating an example of slice frequency information.

FIG. 11 is a flowchart indicating a basic flow of the slice-specific cell reselection procedure.

FIG. 12A is a table indicating a combination of presence or absence of lists according to the first embodiment, and FIG. 12B is a table indicating each example of correspondence relations between the presence or absence of a list and an operation type according to the first embodiment.

FIG. 13A is a table indicating an example of a correspondence relation between operation types and operation content according to the first embodiment, and FIG. 13B is a table indicating each example of area types according to the first embodiment.

FIG. 14 is a diagram illustrating an operation example according to the first embodiment.

### DESCRIPTION OF EMBODIMENTS

A user equipment in a radio resource control (RRC) idle state or an RRC inactive state performs a cell reselection procedure. In the 3GPP, slice-specific cell reselection that is a network slice-dependent cell reselection procedure has been under study.

An aspect of the present disclosure aims to provide a slice support availability checking method in which whether a cell supports a network slice can be checked.

A mobile communication system according to an embodiment is described with reference to the drawings. In the description of the drawings, the same or similar parts are denoted by the same or similar reference signs.

### First Embodiment

### Configuration of Mobile Communication System

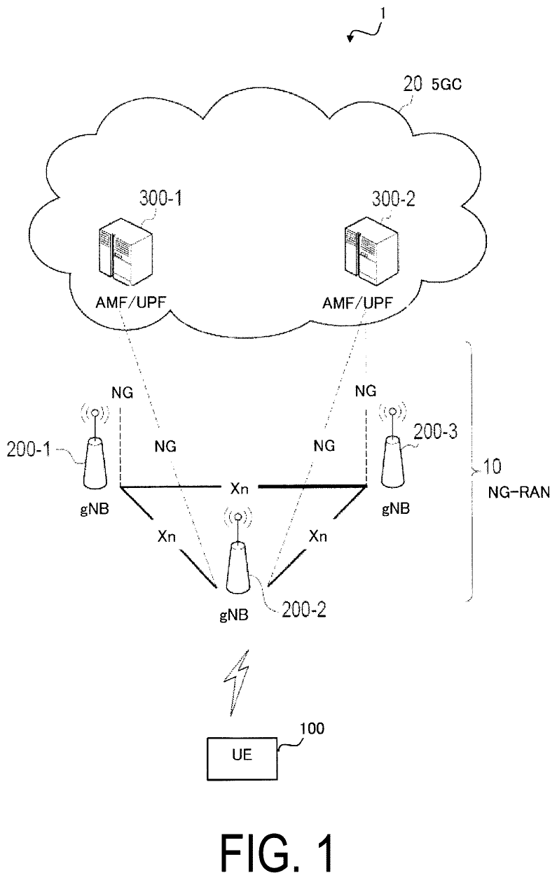

FIG. 1 is a diagram illustrating a configuration of a mobile communication system according to a first embodiment. The mobile communication system 1 complies with the 5th Generation System (5GS) of the 3GPP standard. The description below takes the 5GS as an example, but the Long Term Evolution (LTE) system may be at least partially applied to the mobile communication system. Alternatively, the sixth generation (6G) system may be at least partially applied to the mobile communication system.

The mobile communication system 1 includes a user equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. In addition, the 5GC 20 may be simply referred to as a core network (CN) 20.

The UE 100 is a mobile wireless communication apparatus. The UE 100 may be any apparatus as long as the UE is an apparatus used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Further, the gNB can be connected to an Evolved Packet Core (EPC) corresponding to a core network of LTE. An LTE base station can also be connected to the 5GC. The LTE base station and the gNBs can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNBs 200 via an NG interface which is an interface between a base station and the core network.

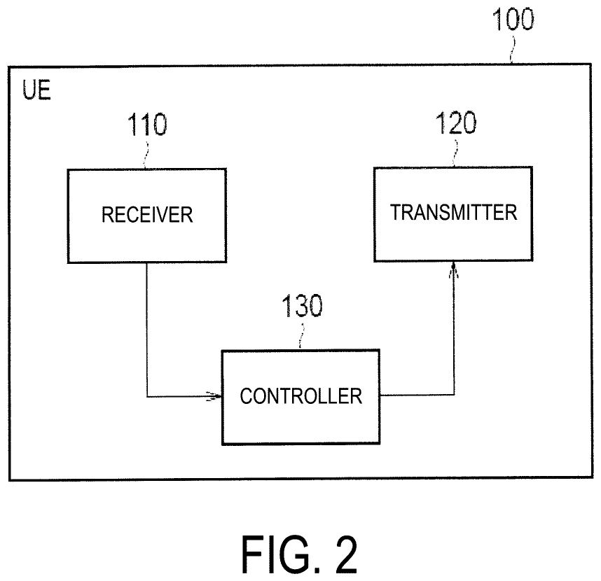

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNBs 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a central processing unit (CPU). The baseband processor performs modulation and demodulation, coding and decoding, and the like of a baseband signal. The CPU executes programs stored in the memory to thereby perform various types of processing. Further, the controller 130 may perform all of the processing and operations in the UE 100 in each embodiment to be described below.

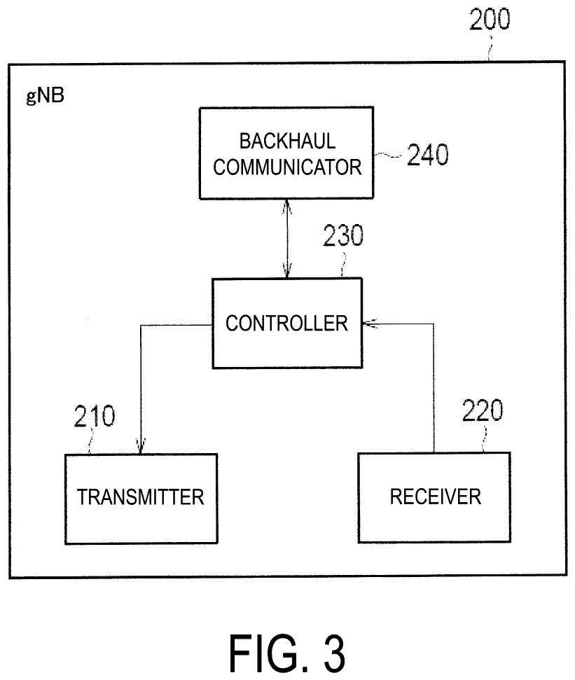

FIG. 3 is a diagram illustrating a configuration of a gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the programs stored in the memory to thereby perform various types of processing. Note that the controller 230 may perform all of the processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and the two units may be connected via an F1 interface, which is a fronthaul interface.

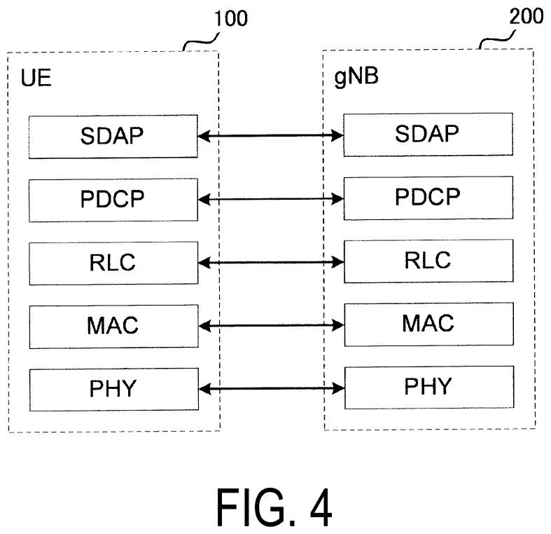

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Further, the PHY layer of the UE 100 receives downlink control information (DCI) transmitted from the gNB 200 over a physical downlink control channel (PDCCH). Specifically, the UE 100 blind-decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through a Hybrid Automatic Repeat reQuest (hybrid ARQ or HARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Further, when the RAN is connected to the EPC, the SDAP need not be provided.

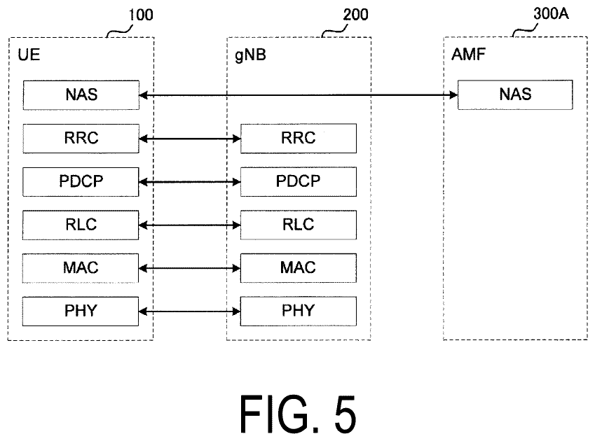

FIG. 5 is a diagram illustrating a configuration of a protocol stack of a radio interface of a control plane handling signaling (control signals).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned above the RRC layer performs session management, mobility management, and the like. NAS signaling is transmitted between the NAS of the UE 100 and the NAS of the AMF 300. Further, the UE 100 includes an application layer other than the protocol of the radio interface. In addition, a layer lower than the NAS is referred to as Access Stratum (AS).

### Overview of Cell Reselection Procedure

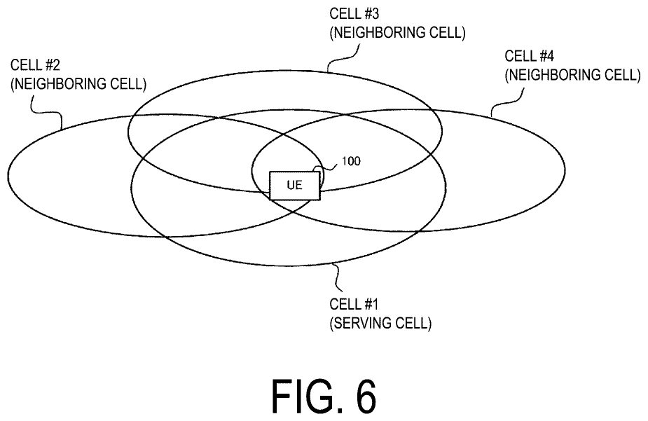

FIG. 6 is a diagram for illustrating an overview of a cell reselection procedure.

The UE 100 in the RRC idle state or the RRC inactive state performs the cell reselection procedure to migrate from a current serving cell (cell #1) to a neighboring cell (any one of cells #2 to #4) according to its movement. To be more specific, the UE 100 specifies a neighboring cell to which the UE is to camp on through the cell reselection procedure and reselects the specified neighboring cell. A frequency (carrier frequency) being the same for the current serving cell and the neighboring cell is referred to as an intra-frequency, and a frequency (carrier frequency) being different for the current serving cell and the neighboring cell is referred to as an inter-frequency. The current serving cell and the neighboring cell may be managed by the same gNB 200 or any different gNBs 200.

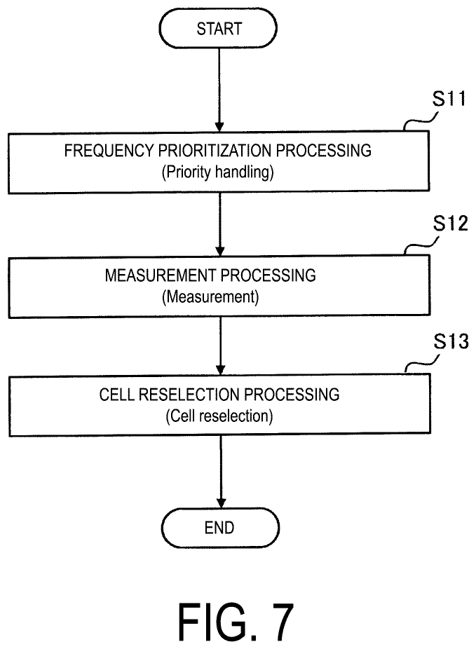

FIG. 7 is a flowchart indicating a schematic flow of a typical (or legacy) cell reselection procedure.

In step S11, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, a Cell Defining-Synchronization Signal and PBCH block (CD-SSB). For example, the UE 100 always measures the radio quality of the frequencies having a higher priority than that of the frequency of the current serving cell, and for frequencies having a priority equal to or lower than the priority of the frequency of the current serving cell, measures the radio quality of the frequencies having a priority equal to or lower than the priority of the frequency of the current serving cell when the radio quality of the current serving cell is below a predetermined quality.

In step S13, the UE 100 performs the cell reselection processing of reselecting a cell to which the UE 100 camps on based on the measurement result in step S20. For example, when the priority of a frequency of a neighboring cell is higher than the priority of the current serving cell and the neighboring cell satisfies a predetermined quality standard (i.e., a minimal required quality standard) for a predetermined period of time, the UE 100 may perform cell reselection for the neighboring cell. When the priorities of the frequencies of the neighboring cells are the same as the priority of the current serving cell, the UE 100 may rank the radio qualities of the neighboring cells to perform cell reselection for the neighboring cells ranked higher than the ranking of the current serving cell for a predetermined period of time. When the priority of the frequency of the neighboring cell is lower than the priority of the current serving cell, the radio quality of the current serving cell is lower than a certain threshold, and the radio quality of the neighboring cell is continuously higher than another threshold for the predetermined period of time, the UE 100 may perform cell reselection for the neighboring cell.

### Overview of Network Slicing

Network slicing is a technique of virtually dividing a physical network (for example, a network including the NG-RAN 10 and the 5GC 20) constructed by a telecommunications carrier to create a plurality of virtual networks. Each virtual network is referred to as a “network slice”. Hereinafter, a network slice may be simply referred to as a “slice”.

Network slicing allows a telecommunications carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

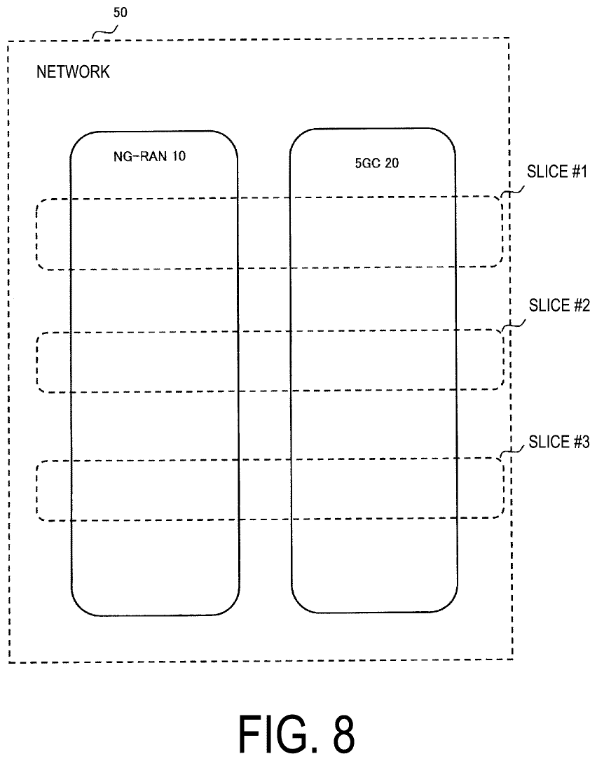

FIG. 8 is a diagram illustrating an example of network slicing.

Three slices (slices #1 to #3) are configured on a network 50 including the NG-RAN 10 and the 5GC 20. The slice #1 is associated with the service type called eMBB, the slice #2 is associated with the service type called URLLC, and the slice #3 is associated with the service type called mMTC. Further, three or more slices may be configured on the network 50. One service type may be associated with a plurality of slices.

Each slice is provided with a slice identifier for identifying the slice. Examples of the slice identifier include Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

In addition, one or more slices may be grouped to configure a slice group. In addition, a slice group is a group including one or more slices, and a slice group identifier is assigned to the slice group. The slice group may be configured by the core network (for example, the AMF 300), or may be configured by the radio access network (for example, a gNB 200). The UE 100 may be notified of the configured slice group.

In addition, the UE 100 determines a desired slice that the UE 100 desires to use. The desired slice may be referred to as an “intended slice”. In the first embodiment, the UE 100 determines a slice priority for each network slice (desired slice). For example, the NAS of the UE 100 determines the slice priority based on an operation status of an application in the UE 100 and/or a user operation/setting, and notifies the AS of slice priority information indicating the determined slice priority.

### Overview of Slice-Specific Cell Reselection Procedure

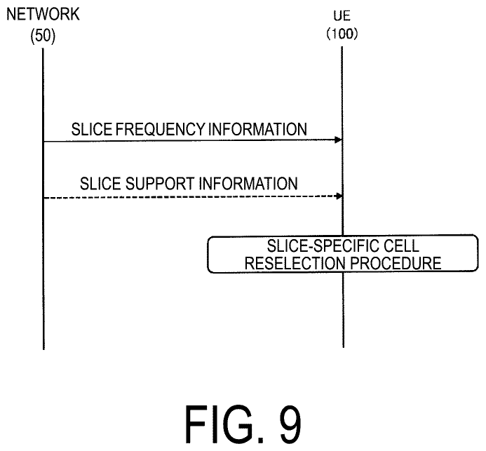

FIG. 9 is a diagram illustrating an overview of a slice-specific cell reselection (slice-aware cell reselection or slice-based cell reselection) procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

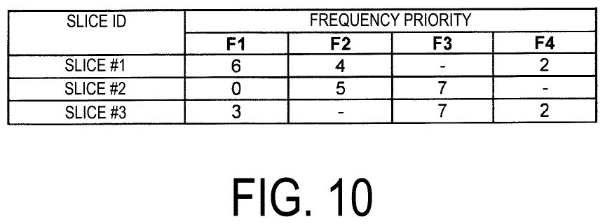

The slice frequency information is information indicating a correspondence relation between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, although the priority is set to be higher as the number of a frequency priority becomes greater, the priority may be higher as the number of a frequency priority becomes smaller.

In addition, three frequencies F1, F2, and F3 are associated with the slice #2 as frequencies that support the slice #2. Among these three frequencies, the frequency priority of F1 is “O”, the frequency priority of F2 is “5”, and the frequency priority of F3 is “7”.

In addition, three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the cell reselection procedure of the related art.

As illustrated in FIG. 9, the UE 100 may perform the cell reselection processing, further based on slice support information provided from the network 50. The slice support information may be information indicating a correspondence relation between cells (for example, a serving cell and each neighboring cell) and network slices that are not provided or provided by the cell. For example, a cell may temporarily fail to provide some or all network slices due to congestion or the like. That is, even if a slice supporting frequency has the capability of providing a certain network slice, some cells within that frequency may not provide that network slice. Based on the slice support information, the UE 100 may ascertain network slices that are not provided by each cell. Such slice support information may be provided from the gNB 200 to the UE 100 through broadcast signaling (for example, a system information block) or dedicated signaling (for example, an RRC release message).

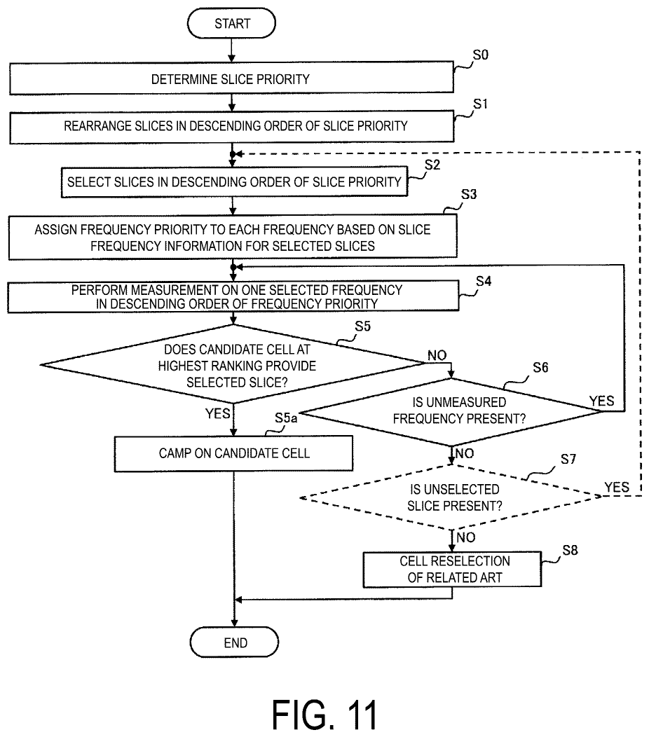

FIG. 11 is a flowchart indicating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information. Further, the “slice-specific cell reselection” procedure indicates a “slice-specific cell reselection procedure”. Further, in the following, “slice-specific cell reselection” and “slice-specific cell reselection procedure” may be used in the same sense.

In step S0, the NAS of UE 100 determines the slice identifiers of the desired slices for the UE 100 and the slice priorities of the desired slices, and notifies the AS of the UE 100 of slice priority information including the determined slice priorities. The “desired slice” is an “Intended slice”, and includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. Although the priority is set to be higher as the number of a slice priority becomes greater, the priority may be higher as the number of a slice priority becomes smaller.

In step S1, the AS of the UE 100 rearranges the slices (slice identifiers), of which the NAS notifies the AS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns a frequency priority to each frequency associated with the selected network slice. To be more specific, the AS of the UE 100 specifies the frequency associated with the slice based on the slice frequency information and assigns a frequency priority to the specified frequency. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 based on the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, a cell satisfying a predetermined quality standard (i.e., a minimal required quality standard) is referred to as a “candidate cell”.

In step S5, the AS of the UE 100 specifies a cell at the highest rank based on the results of the measurement processing in step S4, and determines whether the cell provides the selected network slice based on the slice support information. When determining that the cell at the highest rank provides the selected network slice (step S5: YES), the AS of the UE 100 reselects the cell at the highest rank and camps on that cell in step S5a.

On the other hand, when determining that the cell at the highest rank does not provide the selected network slice (step S5: NO), the AS of UE 100 determines in step S6 whether a frequency not measured is present on the frequency list created in step S3. In other words, the AS of the UE 100 determines whether a frequency to which the frequency priorities have been assigned in step S3 other than the selected frequency is present in the selected network slice. When determining that a frequency not measured is present (step S6: YES), the AS of the UE 100 resumes the processing for the frequency ranked at the next highest frequency priority, and performs the measurement processing using that frequency as a selected frequency (returns to the processing of step S4).

When determining that a frequency not measured is not present on the frequency list created in step S3 (step S6: NO), the AS of the UE 100 may determine in step S7 whether an unselected slice is present on the slice list created in step S1. In other words, the AS of the UE 100 may determine whether a network slice other than the selected network slice is present on the slice list. When determined that an unselected slice is present (step S7: YES), the AS of the UE 100 resumes the processing for the network slice ranked at the next highest slice priority, and selects that network slice as a selected network slice (returns to the processing of step S2). Further, in the basic flow indicated in FIG. 11, the processing of step S7 may be omitted.

When determining that an unselected slice is not present (step S7: NO), the AS of the UE 100 performs cell reselection processing of the related art in step S8. The cell reselection processing of the related art may mean an entirety of the typical (or legacy) cell reselection procedure illustrated in FIG. 7. The cell reselection processing of the related art may also mean only cell reselection processing (step S30) indicated in FIG. 7. In the latter case, the UE 100 may use the measurement result of step S4 without measuring the radio qualities of the cells again.

Further, the typical cell reselection procedure indicated in FIG. 7 may be referred to as a “legacy cell reselection procedure”. In addition, although the procedure of “legacy cell reselection” is referred to as a “legacy cell reselection procedure”, the “legacy cell reselection” and the “legacy cell reselection procedure” may be used without being distinguished from each other in the following description.

### Slice Support Availability Checking Method According to First Embodiment

As described above, in step S3 of slice-specific cell reselection, the UE 100 determines, for example, whether the cell at the highest rank provides the selected network slice based on the slice support information. The slice support information may be information indicating a correspondence relation between cells and network slices not provided or provided by the cells.

Here, for network slices that the slice support information includes, each network slice can also be specified using S-NSSAI. One piece of S-NSSAI, however, is expressed with 32 bits. For this reason, when the slice support information includes a plurality of network slices, the slice support information uses a very large number of bits.

Therefore, grouping a plurality of network slices that the slice support information includes into one (or a plurality of) network slice group is conceivable (hereinafter, referred to as a “slice group function” in some cases). That is, the slice support information may be information indicating a correspondence relation between cells and a network slice group provided or not provided by the cells. Thus, this makes it possible to reduce the number of bits of the slice support information as compared with when S-NSSAI represents each network slice.

However, the 3GPP has suggested a possibility that the slice grouping function would not be introduced. This is because the 3GPP discussed details of the slice group function, such as how to set the maximum number of network slices that a slice group includes.

Therefore, in the first embodiment, a slice support availability checking method capable of checking whether a cell supports a network slice will be described.

To be specific, first, a base station (for example, the gNB 200) transmits a message including a first list and/or a second list. Second, the user equipment (for example, the UE 100) determines whether the cell supports a network slice in an application area based on the presence or absence of the first list and the second list. Here, the first list represents first network slices that the cell supports, and the second list represents second network slices that the cell does not support.

As described above, in the first embodiment, since the UE 100 determines whether the cell supports the slices based on the presence or absence of the first list and the second list, step S3 for the slice-specific cell reselection can be determined.

Here, the first list is, for example, a Physical Cell ID (PCI) Allow list. First, the PCI Allow list may be a list representing cells that support network slices. Alternatively, the PCI Allow list may be a list representing network slices (for example, the first network slices) supported by a cell. Second, the PCI Allow list may be a list representing frequencies that support network slices. Alternatively, the PCI Allow list may be a list representing network slices supported at a frequency. In this case, the frequency represents all cells supporting the frequency. Therefore, when the PCI Allow list represents the relation between the network slices and the frequency, the list represents that all the cells supporting the frequency support the network slices. Further, the cell on the PCI Allow list may be a neighboring cell adjacent to the serving cell.

In addition, the second list is, for example, a PCI Exclude list. First, the PCI Exclude list may be a list representing cells that do not support network slices. Alternatively, the PCI Exclude list may be a list representing network slices (for example, the second network slices) supported by the cell. Second, the PCI Exclude list may be a list representing frequencies that do not support network slices. Alternatively, the PCI Exclude list may be a list representing network slices supported at a frequency. In this case, the frequency represents all cells supporting the frequency. Therefore, when the PCI Exclude list represents the relation between the network slices and the frequency, the list represents that all the cells supporting the frequency do not support the network slices. Further, a cell on the PCI Exclude list may be a neighboring cell adjacent to the serving cell.

The gNB 200 generates a PCI Allow list and/or a PCI Exclude list, and determines an area to which the PCI Allow list and/or the PCI Exclude list is to be applied. The gNB 200 uses homogeneous deployment to determine the area. Homogeneous deployment indicates that target areas are uniform. That is, by applying homogeneous deployment, the relation between a cell (or a frequency) and a network slice indicated by the PCI Allow list and/or the PCI Exclude list can be uniformly applied to the target areas of the homogeneous deployment.

Here, the target areas may be a Tracking Area (TA), a Registration Area (RA), and a Public Land Mobile Network (PLMN). The TA includes one or a plurality of cells, and indicates an area in which the UE 100 in the RRC idle state can move without updating MME. The RA includes one or a plurality of cells, and is defined as a set of TAs. The RA includes a plurality of TAs, and thus the number of times of transmission of registration update signaling can be further reduced than when the registration update signaling is transmitted for each TA. Furthermore, the PLMN indicates a range in which a telecommunications carrier can provide a service.

In addition, the target areas may be areas represented by multiple cells, multiple TAS, multiple RAs, or multiple PLMNs.

As described above, by using homogeneous deployment, the setting of the areas to which the PCI Allow list and/or the PCI Exclude list is applied can be shared by multiple cells, and thus, the gNB 200 and the UE 100 can reduce the processing workload, compared with when an area to which the PCI Allow list and/or the PCI Exclude list is applied is set for each cell.

The gNB 200 transmits a message including the PCI Allow list and/or the PCI Exclude list and an area type indicating the area to which the PCI Allow list and/or the PCI Exclude list is applied. The area type is an identifier indicating an area to which homogeneous deployment is applied. For example, when the area type is “5”, the application area is a PLMN, and when the area type is “4”, the application area is an RA or the like. The message is, for example, an RRC message. That is, the gNB 200 may transmit the message through broadcast signaling (for example, a system information block (SIB)) or dedicated signaling (for example, an RRC release (RRCRelease) message).

Then, the UE 100 determines whether the cell supports the network slices in the area based on the presence or absence of the PCI Allow list and the PCI Exclude list. That is, the UE 100 determines whether the cell supports the network slices according to whether the message includes the PCI Allow list and whether the message includes the PCI Exclude list.

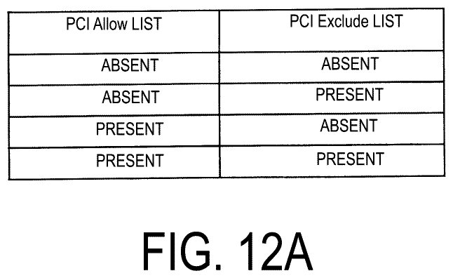

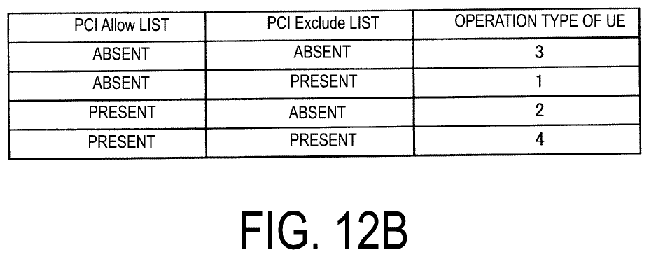

FIG. 12A is a table indicating a combination of presence or absence of the lists according to the first embodiment. In FIG. 12A, “present” indicates that the message includes the lists, and “absent” indicates that the message includes no lists. As indicated by FIG. 12A, there are a total of four types of combinations of whether the message includes the PCI Allow list and the PCI Exclude list.

In the first embodiment, the UE 100 determines operation content indicating an operation mode using the lists based on the combinations of the presence or absence of the PCI Allow list and the PCI Exclude list. The UE 100 determines whether a cell supports network slices based on such operation content.

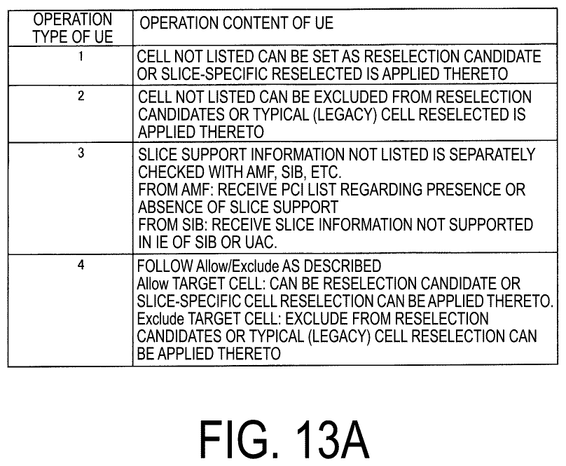

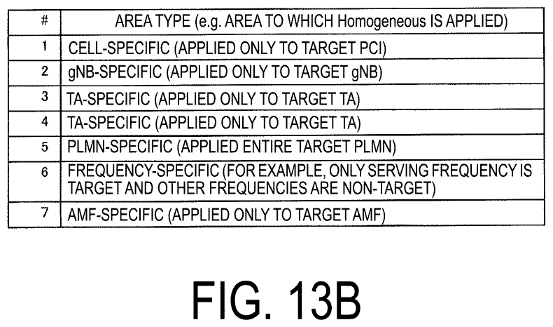

FIG. 12B is a table indicating an example of a correspondence relation between the presence or absence of the lists and operation types according to the first embodiment. In addition, FIG. 13A is a table indicating an example of a correspondence relation between operation types and operation content according to the first embodiment.

First, if the message does not include the PCI Allow list and the PCI Exclude list, the UE 100 performs an operation in accordance with the operation content representing the operation type “3”. That is, the UE 100 separately checks whether the cell supports network slices. If the message includes neither the PCI Allow list nor the PCI Exclude list, the UE 100 is not able to determine whether the cell supports network slices, due to reception of neither the PCI Allow list nor the PCI Exclude list. Thus, the UE 100 separately checks the availability of network slice support. To be more specific, the UE 100 checks the availability of slice support based on the PCI related to slice support included in the NAS message received from the AMF 300. The UE 100 checks the availability of slice support based on slice information in an information element (IE) included in an SIB or unified access control (UAC) broadcast from the gNB 200. The slice information indicates network slices not supported by the cell. The UE 100 determines whether the cell supports network slices based on the received information.

Second, if the message includes the PCI Exclude list and does not include the PCI Allow list, the UE 100 performs an operation in accordance with the operation content representing the operation type “1”. That is, the UE 100 sets a cell not listed in the PCI Exclude list as a reselection candidate in the slice-specific cell reselection. Alternatively, the UE 100 applies slice-specific cell reselection to cells not listed in the PCI Exclude list. That is, when the UE 100 receives the PCI Exclude list but does not receive the PCI Allow list, cells other than the cells excluded from the PCI Exclude list are determined to be cells supporting network slices, and the cells are set as reselection candidates in slice-specific cell reselection.

Third, if the message includes the PCI Allow list and does not include the PCI Exclude list, the UE 100 performs an operation in accordance with the operation content representing the operation type “2”. That is, the UE 100 excludes a cell not listed in the PCI Allow list from the reselection candidates for the slice-specific cell reselection. Alternatively, the UE 100 applies legacy cell reselection to cells not listed in the PCI Allow list. That is, when the UE 100 receives the PCI Allow list but does not receive the PCI Exclude list, cells other than the cells allowed on the PCI Allow list are determined to be cells not supporting network slices, and the cells are excluded from reselection candidates for slice-specific cell reselection. The legacy cell reselection indicated in FIG. 7 may be performed on the cells. In this case, the UE 100 may determine that the cells allowed on the PCI Allow list are cells supporting network slices, and may set the cells as reselection candidates for slice-specific cell reselection (or may apply slice-specific cell reselection to the cells).

Fourth, if the message includes the PCI Allow list and the PCI Exclude list, the UE 100 performs an operation in accordance with the operation content representing the operation type “4”. That is, the UE 100 sets the cells of permission targets listed in the PCI Allow list as reselection candidates for slice-specific cell reselection, or applies slice-specific cell reselection to the cells. Furthermore, the UE 100 excludes the cells of exclusion targets on the PCI Exclude list from the slice-specific cell reselection candidates or applies the legacy cell reselection (FIG. 7) to the cells. That is, upon receiving both the PCI Allow list and the PCI Exclude list, the UE 100 determines whether a cell supports network slices in accordance with each of the lists. To be more specific, when both lists are received, the UE 100 may determine that a cell listed in the PCI Allow list is a cell that supports network slices, and a cell listed on the PCI Exclude list is a cell not supporting network slices. Then, the UE 100 may perform an operation indicated by the operation type “4” based on the determination result.

FIG. 13B is a table indicating examples of area types according to the first embodiment. FIG. 13B indicates identifiers of areas to which the PCI Allow list and/or the PCI Exclude list are uniformly applied. The area type represents areas to which homogeneous deployment is applied. When the area type is “5,” this indicates that the area is a PLMN, and when the area type is “4”, this indicates that the area is an RA as indicated in FIG. 13B. The area to which homogeneous deployment is applied may be indicated by a frequency (area type “6”). In this case, for example, this may indicate that the PCI Allow list and/or the PCI Exclude list are applied to the serving frequency and the PCI Allow list and/or the PCI Exclude list are not applied to the frequencies other than the serving frequency.

### Operation Example According to First Embodiment

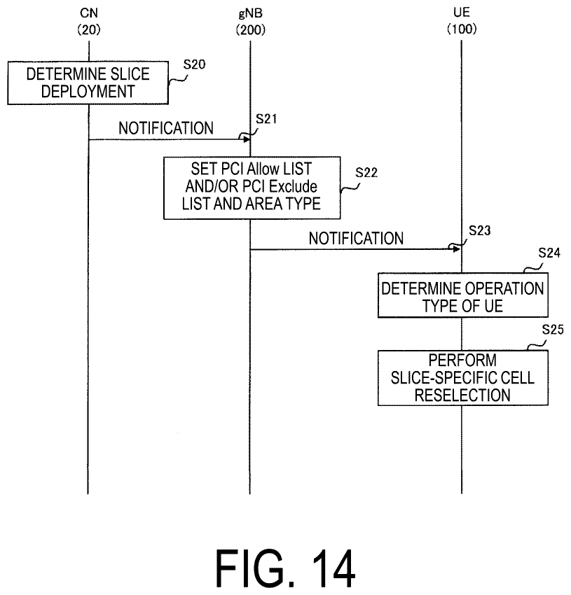

FIG. 14 is a flowchart indicating an operation example according to the first embodiment.

In step S20, the CN 20 determines network slice deployment as indicated in FIG. 14. For example, the AMF 300 determines an area to which homogeneous deployment is applied. The AMF 300 may determine NSSAI (i.e., Configured NSSAI) that can be applied in the PLMN or may determine NSSAI (i.e., Allowed NSSAI) that can be applied in the RA.

In step S21, the AMF 300 notifies the gNB 200 of information about the determined network slice deployment. For example, the AMF 300 transmits, to the gNB 200, an NG message including information about network slice deployment, such as information about an area to which homogeneous deployment is applied. At this time, the AMF 300 may transmit a NAS message including Configured NSSAI and Allowed NSSAI to the UE 100.

In step S22, the gNB 200 sets the PCI Allow list and/or the PCI Exclude list and the area type to which the lists are applied based on the information about the network slice deployment received from the CN 20.

In step S23, the gNB 200 transmits the PCI Allow list and/or the PCI Exclude list and the area type. The gNB 200 may transmit (or broadcast) a message including the PCI Allow list and/or the PCI Exclude list and the area type as an RRC message (for example, an SIB or an RRC release message). Further, the gNB 200 may transmit (or broadcast) the RRC message (for example, the SIB or the RRC release message) including the association information of the presence or absence of the PCI Allow list and the PCI Exclude list and the operation type of the UE 100 (FIG. 13A). The association between the presence or absence of the PCI Allow list and the PCI Exclude list and the operation type of the UE 100 is determined in the specifications, and the UE 100 may operate in accordance with the specifications. In this case, the gNB 200 may not transmit the association information.

In step S24, the UE 100 determines the operation type for the application area based on the presence or absence of the PCI Allow list and the PCI Exclude list. The UE 100 determines whether a cell supports network slices through the determination of the operation type as described above. The UE 100 may determine the operation type in accordance with the association information received from the gNB 200. Alternatively, the UE 100 may determine the operation type in accordance with the specifications.

In step S25, the UE 100 performs slice-specific cell reselection according to the operation type of the UE 100. However, the UE 100 may perform legacy cell reselection in accordance with the operation type.

### Variation of First Embodiment

A variation of the first embodiment is described.

Although an example in which the gNB 200 transmits an area type has been described in the first embodiment, the present invention is not limited to this. For example, the gNB 200 may not transmit an area type. For example, an application area to which the PCI Allow list and/or the PCI Exclude list is applied may be determined in the specifications. The UE 100 can determine and execute the operation type for the application area in accordance with the specifications. However, even in this case, the application area may be a TA, an RA, or a PLMN as in the first embodiment. Alternatively, the application area may be a plurality of cell areas, a plurality of TAs, a plurality of RAs, or a plurality of PLMNs as in the first embodiment.

In addition, although the example in which the presence or absence of the PCI Allow list and the PCI Exclude list and the operation type of the UE 100 are defined in the specifications has been described in the first embodiment, the present invention is not limited thereto. For example, the association between the presence or absence of the PCI Allow list and the PCI Exclude list, the operation type of the UE 100, and an application area (or an area type) may be defined in the specifications. That is, the operation type of the UE 100 is determined according to the presence or absence of the PCI Allow list and the PCI Exclude list, and the application area to which the operation type is applied is determined. For example, when the PCI Allow list is “present” and the PCI Exclude list is “absent” in the specifications, it is assumed that “2” is defined as the operation type and “5” is defined as the application area. In this case, when the PCI Allow list is “present” and the PCI Exclude list is “absent”, the UE 100 performs the operation of the operation type “2” indicated in FIG. 13A and applies a corresponding operation in the area type “5” indicated in FIG. 13B. Also in this case, the gNB 200 may transmit the PCI Allow list and/or the PCI Exclude list, and may not transmit the area type, or may not transmit the association information of the presence or absence of the PCI Allow list and the PCI Exclude list and the operation type of the UE 100. Alternatively, such association may not be defined in the specifications, and such association may be transmitted from the gNB 200 as association information. The gNB 200 may transmit an RRC message including the association information.

### Other Embodiments

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplementary Note

According to an embodiment, (1) a slice support availability checking method of a mobile communication system includes a step of transmitting, at a base station, a message including a first list and/or a second list, and a step of determining, at a user equipment, whether a cell supports a network slice in an application area based on the presence or absence of the first list and the second list, in which the first list represents first network slices that the cell supports, and the second list represents second network slices that the cell does not support.

(2) In the slice support availability checking method of (1) described above, the determining step may further include determining, at the user equipment, whether the cell supports the network slice in accordance with the first list and the second list when the message includes the first list and the second list.

(3) In the slice support availability checking method of (1) or (2) described above, the determining step may further include a step of performing any one of, at the user equipment, receiving slice support information indicating whether the cell supports the network slice from an access management apparatus and receiving the slice support information broadcast from the base station when the message does not include the first list and the second list.

(4) In the slice support availability checking method of any one of (1) to (3) described above, the determining step may further include a step of excluding, at the user equipment, the cell not listed in the first list from slice-specific cell reselection candidates when the message includes the first list and the message does not include the second list.

(5) In the slice support availability checking method according to any one of (1) to (4) described above, the excluding step may further include a step of applying, at the user equipment, legacy cell reselection to the excluded cell.

(6) In the slice support availability checking method of any one of (1) to (5) described above, the determining step may further include a step of setting, at the user equipment, the cell not listed in the second list as a slice-specific cell reselection candidate when the message includes the second list and the message does not include the first list.

(7) In the slice support availability checking method of any one of (1) to (6) described above, the transmitting step may further include a step of transmitting, at the base station, the message including the first list and/or the second list and an area type representing the application area.

According to an embodiment, (8) a user equipment in a mobile communication system includes a receiver that receives, from a base station, a message including a first list and/or a second list, and a controller that determines whether a cell supports a network slice in an application area based on the presence or absence of the first list and the second list, in which the first list represents first network slices that the cell supports, and the second list represents second network slices that the cell does not support.

### REFERENCE SIGNS

1 Mobile communication system
20 CN
100 UE
110 Receiver
120 Transmitter
130 Controller
200 gNB
210 Transmitter
220 Receiver
230 Controller
300 AMF

1. A slice support availability checking method of a mobile communication system, the method comprising the steps of:
transmitting, at a base station, a message comprising a first list and/or a second list; and
determining, at a user equipment, whether a cell supports a network slice in an application area based on the presence or absence of the first list and the second list,
wherein the first list represents first network slices that the cell supports, and
the second list represents second network slices that the cell does not support.

2. The slice support availability checking method according to claim 1, wherein the determining comprises determining, at the user equipment, whether the cell supports the network slice in accordance with the first list and the second list when the message includes the first list and the second list.

3. The slice support availability checking method according to claim 1, wherein the determining comprises performing, at the user equipment, any one of receiving slice support information indicating whether the cell supports the network slice from an access management apparatus and receiving the slice support information broadcast from the base station, when the message does not include the first list and the second list.

4. The slice support availability checking method according to claim 1, wherein the determining comprises excluding, at the user equipment, the cell not listed in the first list from slice-specific cell reselection candidates when the message comprises the first list and the message does not comprise the second list.

5. The slice support availability checking method according to claim 4, wherein the excluding comprises applying, at the user equipment, legacy cell reselection to the excluded cell.

6. The slice support availability checking method according to claim 1, wherein the determining comprises setting, at the user equipment, the cell not listed in the second list as one of the slice-specific cell reselection candidates when the message comprises the second list and the message does not comprise the first list.

7. The slice support availability checking method according to claim 1, wherein the transmitting comprises transmitting, at the base station, the message comprising the first list and/or the second list and an area type representing the application area.

8. A user equipment in a mobile communication system, comprising:
a receiver configured to receive, from a base station, a message comprising a first list and/or a second list; and
a controller configured to determine whether a cell supports a network slice in an application area based on the presence or absence of the first list and the second list,
wherein the first list represents first network slices that the cell supports, and
the second list represents second network slices that the cell does not support.
